(19) United States
(12) Patent Application Publication
(10) Pub. No.: US 2025/0390612 A1
(43) Pub. Date: Dec. 25, 2025

(54) SECURITY RING FOR INTEGRATED CIRCUITS

(71) Applicant: XILINX, INC., San Jose, CA (US)

(72) Inventors: James ANDERSON, Madison, AL (US); James D. WESSELKAMPER, Albuquerque, NM (US); Thomas Paul LEBOEUF, Sandia Park, NM (US); Jason J. MOORE, Albuquerque, NM (US)

(21) Appl. No.: 18/751,169

(22) Filed: Jun. 21, 2024

(51) Int. Cl. G06F 21/75

(52) U.S. Cl. CPC G06F 21/75

(57) ABSTRACT

Embodiments herein describe a security ring for integrated circuit. In an example, a first die includes functional circuitry within an inner region, and a first security ring surrounding the functional circuitry. A second die includes protection circuitry (e.g., tamper detection circuitry) within an inner region, and a second security ring surrounding the protection circuitry. The first security ring sends probing signals to the protection circuitry via the second security ring, receives probing responses from the protection circuitry via the second security ring, determines a physical status of the protection circuitry based on the probing responses, and initiates a remedial action if the physical status of the protection circuitry indicates physical tampering of the protection circuitry.

### TECHNICAL FIELD

Examples of the present disclosure generally relate to protecting integrated circuits from physical tampering and, more particularly, to a security ring for integrated circuits.

### BACKGROUND

An integrated circuit (IC) device may be subjected to a physical attack to access data and/or to reverse engineer the IC device. A physical attack may involve de-capsulation (removing packaging) and de-layering/thinning to observe and/or alter operation of the IC (e.g., using a focused ion beam (FIB) device). The IC device may be altered to disable protection circuitry and/or to re-route and capture data. There is a need to preclude or reduce the effectiveness of such physical attacks.

### SUMMARY

Techniques for a security ring for integrated circuits are described. One example is an integrated circuit (IC) device that includes a first die having functional circuitry within an inner region and a first security ring surrounding the functional circuitry, and a second die having protection circuitry (e.g., tamper detection circuitry) within an inner region and a second security ring surrounding the protection circuitry. The first security ring may send probing signals to the protection circuitry via the second security ring, receive probing responses from the protection circuitry via the second security ring, determine a physical status of the protection circuitry based on the probing responses, and initiate a remedial action if the physical status of the protection circuitry indicates physical tampering of the protection circuitry.

Another example described herein is system that includes a computing platform and a user interface, where the computing platform includes a plurality of integrated circuit (IC) devices, and where one or more of the IC devices includes a first die having functional circuitry within an inner region and a first security ring surrounding the functional circuitry, and a second die that includes protection circuitry within an inner region and a second security ring surrounding the protection circuitry. The first security ring may send probing signals to the protection circuitry via the second security ring, receive probing responses from the protection circuitry via the second security ring, determine a physical status of the protection circuitry based on the probing responses, and initiate a remedial action if the physical status of the protection circuitry indicates physical tampering of the protection circuitry.

Another example described herein is a non-transitory computer readable medium encoded with a computer program that includes instructions to cause a processor to place a functional circuit design within an inner region of a first die template, where the first die template includes a first security ring placed in an outer region of the first die template, the first security ring surrounds the functional circuitry, and the first security ring is designed to determine if the IC die is subject to a physical attack.

The computer program may include additional instructions to cause the processor to provide the design with a second die template having a protection circuit design placed within an inner region and a second security ring placed in an outer region, where the second security ring surrounds the protection circuitry, the second security ring is designed to interface between the first security ring and the protection circuitry, and the protection circuit is designed to sense a physical attack on the IC device. Alternatively, the additional instructions may cause the processor to place one of multiple selectable protection circuit designs within the inner region of the die template.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A is a cross-sectional depiction of an integrated circuit (IC) device, according to an embodiment.

FIG. 1B is a cross-sectional depiction of the IC device, according to another embodiment.

FIG. 1C is a cross-sectional depiction of the IC device, as depicted in FIG. 1A, attached to a layer (e.g., a package substrate, an interposer, or a printed circuit board), according to an embodiment.

FIG. 2A depicts a first die of the IC device, including functional circuitry and a first security ring, according to an embodiment.

FIG. 2B is depicts first die of the IC device, according to another embodiment.

FIG. 3 depicts the first security ring, according to an embodiment.

FIG. 4A depicts a second die of the IC device, including protection circuitry and a second security ring, according to an embodiment.

FIG. 4B depicts the second die in which the protection circuitry includes multiple sensing circuits or sensing tiles, according to an embodiment.

FIG. 5 depicts the functional circuitry of the first die, according to an embodiment.

FIG. 6 depicts a method 600, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe a security ring for integrated circuits. The security ring includes processors arranged in a ring surrounding functional circuitry of a first integrated circuit (IC) die. The processors perform tamper-detection functions, independent of one another, and communicate with one another in a ring-type format, such that if any of the processors detects a tamper event, or if communication with any of the processors is disrupted, remedial action is initiated. The security ring may also serve as a physical shield for the functional circuitry from side-based/horizontal probing attacks. The security ring may be used alone and/or in combination with a second IC die that includes protection circuitry (e.g., tamper detection circuitry) and a corresponding security ring, to further protect the functional circuitry. The security ring of the second IC may include interface circuits that interface between the protection circuitry and the security ring of the first IC die. The security ring of the second IC may further include processors, similar to the security ring of the first IC die. The security ring of the first and/or second IC die may further include additional protection circuitry, such as entropy sensors.

A security ring, as disclosed herein, may be useful to protect functional circuitry of a variety of device types such as, without limitation, a computer, a server, a tablet, a printer, a digital imaging device, a smart phone, a control system, an automated teller machine, transportation system, and/or solid-state memory. In an example, a system includes a computing platform and a user interface that interfaces between the computing platform and a user, and the computing platform includes a plurality of integrated circuit (IC) devices, one or more of which include a security ring as disclosed herein.

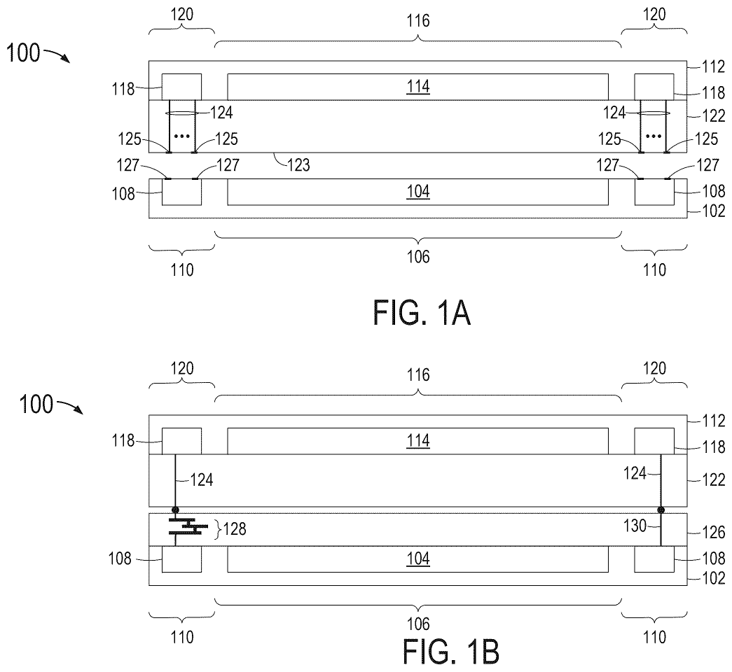

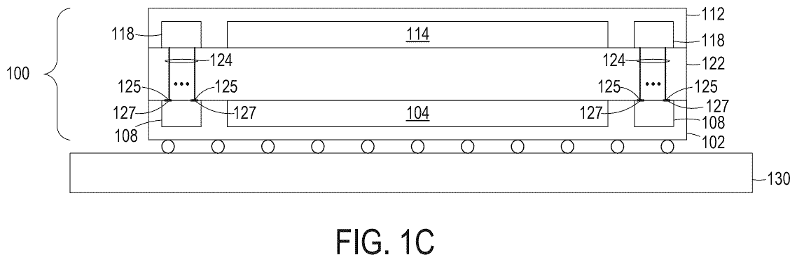

FIG. 1A is a cross-sectional depiction of an integrated circuit (IC) device 100, according to an embodiment. In the example of FIG. 1A, IC device 100 includes multiple vertically-stacked dies. The dies include a first die 102 having functional circuitry 104 disposed within an inner region 106, and a security ring 108 disposed within an outer region 110.

IC device 100 further includes a second die 112 having protection circuitry 114 disposed within an inner region 116, and a security ring 118 disposed within an outer region 120. Protection circuitry 114 may include sensing circuits that detect physical tampering of IC device 100 (e.g., de-capsulation/delayering/thinning). The sensing circuits may include, without limitation, capacitive sensing circuits, impedance sensing circuits, optical sensing circuits, memory devices (e.g., configured as linked shift registers), and/or other sensing circuit(s). Then sensing circuits may be arranged as an array or network of interconnected sensing circuits.

Security ring 108 may initiate sensing functions of protection circuitry 114 via security ring 118. Security ring 108 may also receive sensing data from protection circuitry 114 via security ring 118, and may process/evaluate the sensing data to validate the physical integrity of protection circuitry 114. If security ring 108 determines that functional circuitry 114 has been tampered, security ring 108 may further determine coordinates of the tampering based on the sensing data. Alternatively, or additionally, security ring 108 may determine that IC device 100 has been tampered if there is a disruption in communications within security ring 108, a disruption in communications between security ring 108 and security ring 118, and/or a disruption in communications between security ring 118 and protection circuitry 114. Security ring 108 and/or security ring 118 may include additional protection circuitry such as, without limitation, entropy sensors. Security rings 108 and 118, in combination with protection circuitry 114, may serve as a protective shield around functional circuitry 104.

A substrate 122 of second die 112 may have metal-filled, through-silicon vias (TSVs) 124 to provide electrical connections between contacts/signals of security ring 118 and a surface 123 of substrate 122. Substrate 122 and first die 102 may further include respective contacts 125 and 127 to provide electrical connections between metal-filled TSVs 124 and contacts/signals of security ring 108. Contacts 125 and 127 may represent, for example and without limitation, hybrid bonding contacts. Hybrid bonding techniques provide higher-density chip-to-chip (C2C) solutions than bumps, such as solder bumps or micro-bumps (μbumps), which may also be referred to as C4 bumps.

FIG. 1B is a cross-sectional depiction of IC device 100, according to another embodiment. In the example of FIG. 1B, first die 102 further includes a layer 126, which may represent a substrate or a metal layer(s). Where layer 126 represents a substrate, the substrate may have metal-filled TSVs 130 to provide electrical connections between TSVs 124 and security ring 108. Where layer 126 represents a metal layer(s), the metal layer(s) may be patterned to provide electrical connections 128 between TSVs 124 and security ring 108. In this example, electrical connections between TSVs 124 and TSVs 130/electrical connections 128 may be provided with hybrid bonds and/or bumps.

FIG. 1C is a cross-sectional depiction of IC device 100, as depicted in FIG. 1A, attached to a layer 130, according to an embodiment. Layer 130 may represent a package substrate, an interposer that connects first die 102 to one or more other dies, or a printed circuit board (PCB).

In the examples of FIGS. 1A, 1B, and 1C, IC device 100 is illustrated as two vertically-stacked dies. IC device 100 may include one or more additional dies. IC device 100 may include one or more additional dies between first die 102 and layer 202, between first die 102 and second die 112, above second die 102, and/or between first and second dies 102 and 112. The one or more additional dies may include functional circuitry, protection circuitry similar to protection circuitry 114, and/or a security ring (e.g., similar to security ring 108 or security ring 118). As an example, a third die, similar to second die 112, may be placed between first die 102 and layer 202 to detect tampering directed to a backside of IC device 100 (e.g., via substrate thinning). In another embodiment, second die 112 may be omitted from IC device 100.

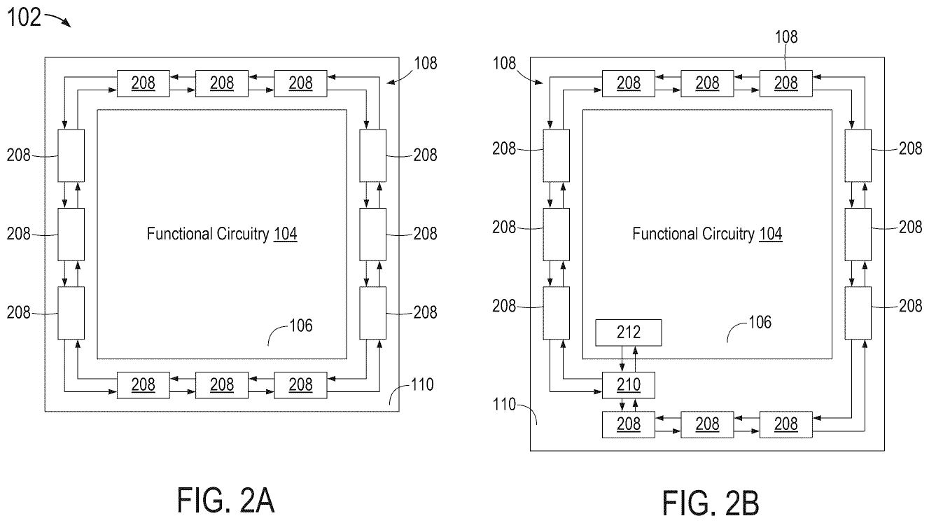

FIG. 2A depicts first die 102, according to an embodiment. In the example of FIG. 2A, security ring 108 includes security tiles 208 arranged in a ring surrounding functional circuitry 104. Security tiles 208 may include processors, memory, interface circuitry, and/or other circuitry such as additional protection circuity (e.g., entropy sensors).

FIG. 2B depicts first die 102, according to another embodiment. In the example of FIG. 2B, security ring 108 includes security tiles 208 arranged in a ring surrounding functional circuitry of inner region 106, as in FIG. 2A, and further includes a security tile 210 placed between the ring of security tiles 208 and inner region 106. Security tile 210 may interface between security tiles 208 and management circuitry 212 (e.g., a platform management controller). Security tile 210 may be referred to as a primary security tile, and security tiles 208 may be referred to as secondary security tiles. Placing primary security tile 210 between the ring of secondary security tiles 208 and functional circuitry 104 may be useful to shield primary security tile 210 from physical attack.

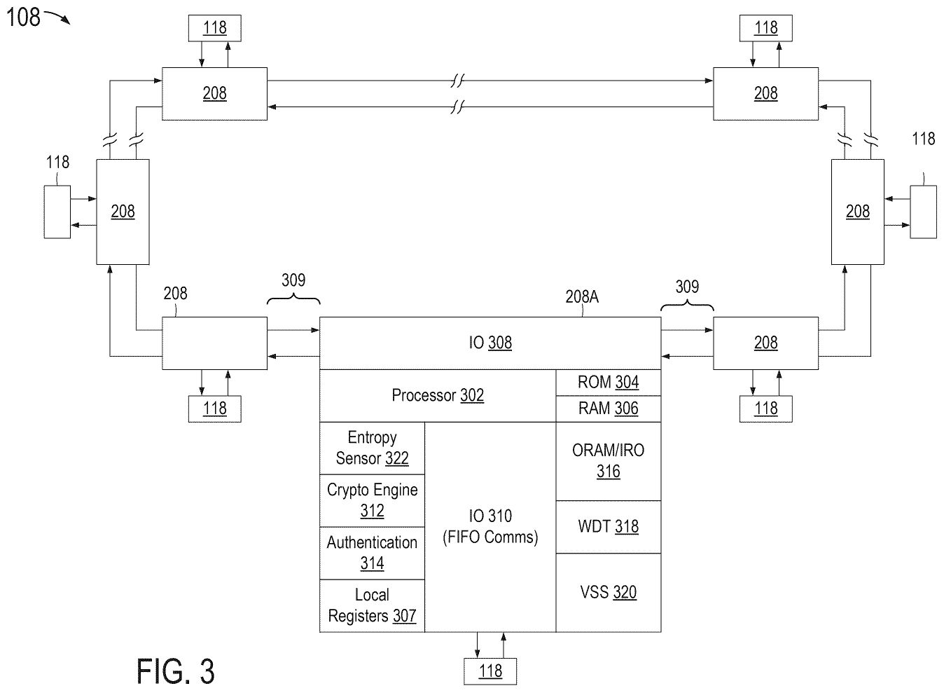

FIG. 3 depicts security ring 108, according to an embodiment. In the example of FIG. 3, a security tile 208A includes a processor 302, which may include, for example and without limitation, a reduced-instruction set architecture (ISA) processor. Security tile 208A further includes read-only memory (ROM) 304, random-access memory (RAM) 306, and registers 307. ROM 304 may include a computer program containing instructions to be executed by processor 302. Processor 302 may use RAM 306 and/or registers 307 to hold the instructions and/or data, while executing the instructions.

Security tile 208A further includes input/output (IO) circuitry 308 to communicate with one or more other security tiles 208. In the example of FIG. 3, IO circuitry 308 interfaces with adjacent/neighboring security tiles 208 via point-to-point communication links 309, which may be based on an advanced extensible interface (e.g., AXI) protocol. Alternatively, or additionally, security tiles 208 may communicate with one another via a bus and/or a packet-switched network, such as a network-on-chip (NoC).

Security tile 208A further includes IO circuitry 310 to communicate with security ring 118 of second die 112. In the example of FIG. 3, IO circuitry 310 is illustrated as first-in/first-out (FIFO) communication circuitry. IO circuitry 310 is not, however, limited to FIFO communication circuitry.

Security tile 208A may include one or more additional circuit blocks, examples of which are provided below. Security tile 208A is not, however, limited to the following examples.

Security tile 208A may further include a cryptographic engine 312. Cryptographic engine 312 may encrypt and/or decrypt data exchanged via IO circuitry 308 and/or IO circuitry 308. Alternatively, or additionally, cryptographic engine 312 may encrypt data/instructions to be stored in ROM 304 and/or RAM 306, and/or may decrypt data data/instructions retrieved from ROM 304 and/or RAM 306.

Security tile 208A may further include authentication circuitry 314, which may include hashing circuitry to compute and/or compare hash values based on a hash function. Authentication circuitry 314 may be useful for authenticating instructions to be stored in and/or retrieved from ROM 304 and/or RAM 306, and/or for authenticating other circuit blocks (e.g., other security tiles 208, security ring 118, and/or protection circuitry 114).

Security tile 208A may further include Oblivious RAM (ORAM) circuitry, illustrated here as Integrity-Reliability Enhanced Ring ORAM (IRO) circuitry 316. IRO circuitry 316 may be useful to hide memory access patterns from untrusted/un-authenticated circuitry. IRO circuitry 316 may interface between RAM 306 and processor 302 and/or other circuitry that has direct memory access to RAM 306 (e.g., processors of other security tiles 208 and/or security ring 118). IRO circuitry 316 may, for example, query/access RAM 306 on behalf of an access requestor, without disclosing information regarding about memory access patterns related to RAM 306.

Security tile 208A may further include a watchdog timer (WDT) circuit 318. WDT circuity 318 may be useful for recovering from malfunctions.

Security tile 208A may further include volume snapshot service (VSS) circuitry 320. VSS circuitry 320 may be useful to create backup copies or snapshots of data (i.e., shadow copies), even if the data is in use. VSS circuitry 320 may be omitted from primary security tile 210 (i.e., in an embodiment that includes primary security tile 210).

Security tile 208A may further include one or more sensors, illustrated here as an entropy sensor 322.

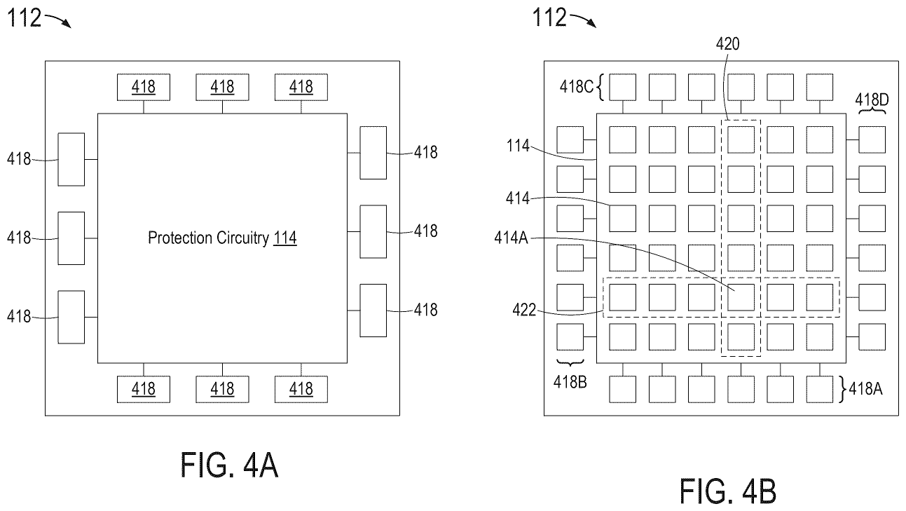

FIG. 4A depicts second die 112, according to an embodiment. In the example of FIG. 4A, security ring 118 includes security tiles 418 arranged in a ring surrounding protection circuitry 114. In an example, there is a one-to-one relationship between security tiles 208 of first die 102 and security tiles 418 of second die 112. In another embodiment, there is not a one-to-one relationship between security tiles 208 and 418. Security tiles 418 may be similar to security tiles 208 or may differ from security tiles 208. As an example, security tiles 418 may include interface circuits that interface between security tiles 208 and protection circuitry 114. Security tiles 418 may further include additional protection circuitry, such as entropy sensors.

FIG. 4B depicts second die 112 in which protection circuitry 114 includes multiple sensing circuits or sensing tiles 414, according to an embodiment. Sensing tiles 414 may be arranged as an array of addressable sensing tiles. In an example, sensing tiles 414 propagate signals (e.g., probing signals) along rows and columns of sensing tiles 414, such that security ring 108 can detect a location of a tamper event based on cross-correlation (e.g., based on intersecting faults). Sensing tiles 414 are not, however, limited to the foregoing example.

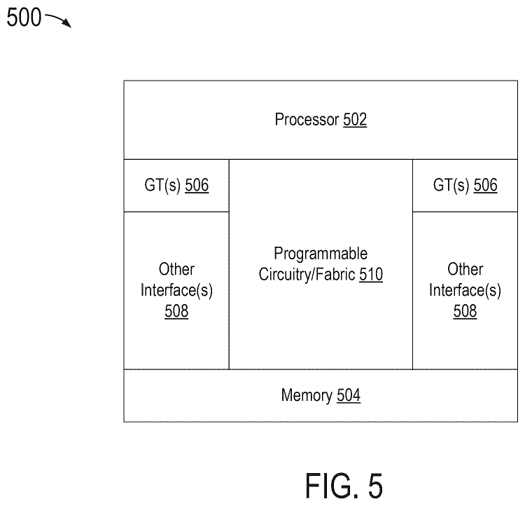

Functional circuitry 104 may include a variety of types of circuitry and may perform one or more of a variety of functions such as, without limitation, encryption, communication, graphic processing, and/or inferencing (e.g., executing a trained machine-learning model). FIG. 5 depicts functional circuitry 500, according to an embodiment. In the example of FIG. 5, functional circuitry 500 includes a processor 502 and memory 504. Memory 504 may include program memory for storing a computer program that includes instructions to be executed by processor 502. Memory 504 may further include data memory (e.g., buffers and/or registers), which processor 502 may use while executing the computer program. Functional circuitry 500 may further include interface circuitry, illustrated here as gigabit transceivers (GTs) 506 and other interface(s) 508. Functional circuitry 500 may further include logic circuitry and interconnects, which may be configurable/programmable. In the example of FIG. 5, the logic circuitry and interconnects are collectively illustrated as programmable circuitry/fabric 510. Functional circuitry 500 is not limited to the example of FIG. 5. Functional circuitry 104 (FIGS. 1, 2A, and 2B) may include one or more instances of functional circuitry 500. Functional circuitry 104 may, for example, include an array of compute tiles, each including an instance of functional circuitry 500 or a portion thereof.

Placing security rings 108 and 118 at peripheries of dies 102 and 112 may protect dies 102 and 112 from side-based physical attacks. Placing security rings 108 and 118 at peripheries of functional circuitry 104 and protection circuitry 114 may be useful to accommodate various/changing designs of functional circuitry 104 and protection circuitry 114.

As an example, a circuit design tool may include a first template for first die 102 that includes a layout of security ring 108 and interconnections within layer 126. The design tool may further include a second template for second die 112 that includes a layout of security ring 118 and TSVs 124 of substrate 122. Such templates may be referred to as design-agnostic templates. The circuit design tool may place a desired functional circuit design within inner region 106 of the first template, and may place desired protection circuitry within inner region 116 of the second template. The circuit design tool may further route electrical connections between security ring 108 and management control circuitry of the functional circuitry, between security ring 118 and the protection circuitry. The desired protection circuitry may represent an existing design or a new design. In an example, the circuit design tool may further include one or more selectable templates for the protection circuitry and/or for selectable sensing tiles. Design-agnostic templates, as described above, may be applied to a design for an existing IC device and/or to a design for a new IC device, with relatively little design changes to the design.

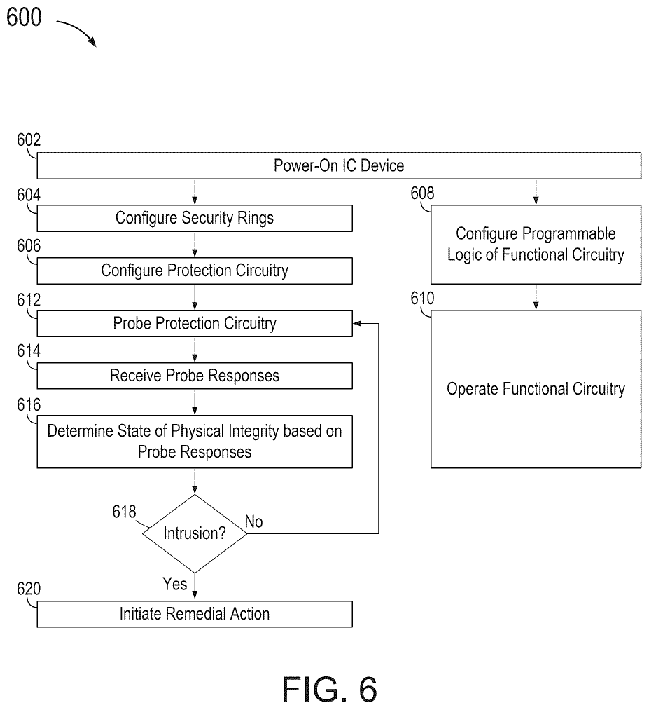

FIG. 6 depicts a method 600, according to an embodiment. Method 600 is described below with reference to FIGS. 1-5. Method 600 is not, however, limited to the examples of FIGS. 1-5.

At 602, power is applied to IC device 100.

At 604, management circuitry 212 and/or an external device may configure security ring 108 and/or security ring 118 on power-up. In an example, management circuitry 212 provides code (i.e., computer programs) to security tiles 208 (and security tile 210, where applicable). The code provided to security tiles 208 may include instructions for interfacing amongst security tiles 208 and/or for interfacing with security tiles 418 and/or protection circuitry 114. The code provided to security tiles 208 may include instructions for processing sensing data (e.g., probing responses) from protection circuitry 114.

Management circuitry 212 may directly load the code in ROM 304 of security tiles 208. Alternatively, authentication circuitry 514 of security tiles 208 may first validate the code (e.g., based on an image or signature stored in firmware), and/or cryptographic engines 512 of security tiles 208 may decrypt the code.

Management circuitry 212 may provide substantially similar code to each security tile 208 (e.g., security tiles 208 may be configured to perform similar operations with respect to corresponding rows and/or columns of sensing tiles 414). Alternatively, management circuitry 212 may provide differing code to security tiles 208. Management circuitry 212 may, for example, configure a subset of security tiles 208 to perform protection-related functions, and may allow remaining security tiles 208 to go unused and/or to provide other services. Management circuitry 212 may configure security tiles 208 differently with each re-boot. This may be useful to reduce the ability of an attacker to discover how security ring 108 operates.

In another embodiment, management circuitry 212 configures/programs primary security tile 210, and primary security tile 210 programs/configures secondary security tiles 208. Alternatively, computer programs for security tiles 208 may be pre-loaded (e.g., firmware-embedded within respective security tiles 208).

Management circuitry 212 may also configure interconnections amongst security tiles 208, interconnections between security tiles 208 and security ring 118, and/or interconnections between security ring 118 and protection circuitry 114. Alternatively, the code provided to security tiles 208 may further include instructions for configuring security ring 118, protection circuitry 114, and/or interconnections between security ring 118 and protection circuitry 114.

At 606, management circuitry 212 and/or security ring 108 may configure protection circuitry 114. Management circuitry 212 and/or security ring 108 may, for example, configure (e.g., enable/disable) features of protection circuitry 114, and/or may configure interconnections amongst sensing tiles 414 of protection circuitry 114.

Upon successful configuration of security rings 108 and 118, and protection circuitry 114, security rings 108 and 118 and protection circuitry 114 transition to an operating mode to protect functional circuitry 104 from physical attack. Examples are provided further below with reference to 612 through 620.

At 608, management circuitry 212 may configure functional circuitry 104. Where functional circuitry 104 includes programmable circuitry/fabric 510, management circuitry 212 may populate configuration random-access memory (CRAM) of with configuration parameters. Management circuitry 212 may configure programmable circuitry/fabric 410 prior to, during, or subsequent to configuring security rings 108 and 118, and protection circuitry 114, at 604 and 606.

At 610, functional circuitry 104 transitions to an operating mode. In an example, functional circuitry 104 does not transition to the operating mode until security ring 108 determines that IC device is structurally intact (i.e., tamper-free), such as described further below.

In an embodiment, management circuitry 212 may dynamically re-configure security tiles 208, security tiles 418, protection circuitry 114, and/or interconnections amongst security tiles 208, security tiles 418, and/or protection circuitry 114, while functional circuitry 104 is in the operating mode (i.e., during run-time). Re-configuring interconnections may be useful to reduce the ability of an attacker to determine/learn protection functions of IC device 100.

At 612, security ring 108 (i.e., one or more of security tiles 208) interfaces with security ring 118 to determine a status of protection circuitry 114. Security ring may send probing signals to protection circuitry 114 to initiate sensing and/or reporting functions of protection circuitry 114. The probing signals may include control signals, such as read and write commands, and/or data.

In an example, sensing tiles 414 in FIG. 4B include addressable memory (e.g., shift registers) that propagate signals along rows and columns. In this example, security ring 108 may send probing signals to security tiles 418A and 418B, which may propagate the probing signals through respective columns and rows of sensing tiles 414, towards opposing security tiles 418C and 418C. If inner region 116 of second die 112 is physically tampered, one or more sensing tiles 414 may fail to properly propagate the probing signal along the corresponding row(s) and column(s). In another example, security ring 108 may send probing signals to security tiles 418A, 418B, 418C, and 418, which may propagate the probing signals through respective columns and rows of sensing tiles 414, in a bi-directional manner.

At 614, security ring 108 receives probe responses from security ring 118.

At 616, security ring 108 (i.e., one or more of security tiles 208) determines a state of physical integrity of protection circuitry 114 based on the probe responses. Continuing with the example above, if security ring 108 detects a faulty probe response from a column 420 and a row 422, security ring 108 may a identify sensing circuit 414A as a source of the faulty probe responses based on an intersection of column 420 and row 422. In this example, security ring 108 may determine that a physical region of sensing circuit 414A has been physically tampered.

In an example, security tiles 208 receive probe responses from respective security tiles 418, and each security tile 208 determines whether the corresponding response probe response is faulty. Security tiles 208 may report the probe statuses to a designated one of security tiles 208 (or to primary security tile 210, if applicable) and/or to multiple other security tiles 208. In this example, the designated security tile determines the status of protection circuitry 114 based on the probe responses (e.g., determines intersections of faulty rows and columns). In another example, probe response are routed from security tiles 418 to a subset of one or more designated security tiles 208 for evaluation. The routing may be configurable, such as described further above with reference to 604.

Security ring 108 may also determine whether there is a disruption in communications amongst security tiles 208, between security ring 108 and security ring 118, and/or between security ring 118 and protection circuitry 114. If security ring 108 determines there is a disruption in communications, security ring 108 may determine that IC device 100 has been physically tampered.

At 618, if security ring 108 determines that protection circuitry 114 and/or IC device 100 has been physically tampered, security ring 108 may initiate remedial/mitigation action at 620, such as by notifying management circuitry 212. Management circuitry 212 may perform or invoke one or more remedial/mitigation actions, which may include alerting an external device and/or a user, and/or precluding and/or halting operation of functional circuitry 104 or a portion thereof.

Security ring 108 may probe protection circuitry 114 prior to operating functional circuitry 104 at 620, and/or while functional circuitry 104 operates at 620. Security ring 108 may, for example, probe protection circuitry 114 during run-time based on a timer and/or other event.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) device, comprising:
a first die having functional circuitry within an inner region of the first die, and a first security ring surrounding the functional circuitry; and
a second die comprising protection circuitry within an inner region of the second die, and a second security ring surrounding the protection circuitry;
wherein the first security ring is configured to,
send probing signals to the protection circuitry via the second security ring,
receive probing responses from the protection circuitry via the second security ring,
determine a physical status of the protection circuitry based on the probing responses, and
initiate a remedial action if the physical status of the protection circuitry indicates physical tampering of the protection circuitry.

2. The IC device of claim 1, wherein the first security ring is further configured to:
determine if a communication link is disrupted, wherein the communication link comprises one or more of a communication link within the first security ring, a communication link between the first security ring and the second security ring, and a communication link between the second security ring and the protection circuitry; and
initiate the remedial action if the first security ring determines that the communication link is disrupted.

3. The IC device of claim 1, wherein the first security ring comprises a ring of security tiles surrounding the functional circuitry, and wherein a first one of the security tiles comprises:
a processor;
memory;
first interface circuitry configured to communicate with one or more other ones of the security tiles; and
second interface circuitry configured to communicate with the second security ring.

4. The IC device of claim 3, wherein the first security tile further comprises one or more of:
a cryptography engine;
an authentication engine; and
integrity-reliability enhanced ring oblivious memory (IRO) circuitry.

5. The IC device of claim 3, wherein first interface circuitry comprises point-to-point interface circuitry to communicate with another one of the security tiles based on a point-to-point interface protocol.

6. The IC device of claim 3, wherein first interface circuitry comprises packet-based network-on-chip (NoC) circuitry to communicate with other ones of the security tiles over packet-based NoC communication infrastructure.

7. The IC device of claim 3, wherein the security tiles are configured to:
determine physical statuses of respective regions of the protection circuitry based on probing responses from the respective regions of the protection circuitry; and
report the physical statuses amongst the security tiles.

8. The IC device of claim 7, wherein the security tiles are further configured to:
determine a status of communication links, wherein the communication links comprise one or more of communication links between the security tiles and the respective regions of the protection circuitry and communication links amongst the security tiles; and
report the status of the communication links amongst the security tiles.

9. The IC device of claim 3, wherein one or more of the security tiles is configured to determine a region of the protection circuitry subject to the physical tampering based on the probing responses.

10. The IC device of claim 1, wherein the first security ring is configurable with respect to one or more of:
functions performed by processors of the first security ring;
interconnections amongst the processors of the first security ring; and
interconnections between the first security ring and the second security ring.

11. A system, comprising:
a plurality of integrated circuit (IC) devices, wherein one or more of the IC devices comprises,
a first die having functional circuitry within an inner region of the first die, and a first security ring surrounding the functional circuitry, and
a second die comprising protection circuitry within an inner region of the second die, and a second security ring surrounding the protection circuitry;
wherein the first security ring is configured to,
send probing signals to the protection circuitry via the second security ring,
receive probing responses from the protection circuitry via the second security ring,
determine a physical status of the protection circuitry based on the probing responses, and
initiate a remedial action if the physical status of the protection circuitry indicates physical tampering of the protection circuitry; and
wherein the system further comprises a user interface configured to interface between the functional circuitry and a user.

12. The system of claim 11, wherein the first security ring is further configured to:
determine if a communication link is disrupted, wherein the communication link comprises one or more of a communication link within the first security ring, a communication link between the first security ring and the second security ring, and a communication link between the second security ring and the protection circuitry; and
initiate the remedial action if the first security ring determines that the communication link is disrupted.

13. The system of claim 11, wherein the first security ring comprises a ring of security tiles surrounding the functional circuitry, and wherein a first one of the security tiles comprises:
a processor;
memory;
first interface circuitry configured to communicate with one or more other ones of the security tiles; and
second interface circuitry configured to communicate with the second security ring.

14. The system of claim 13, wherein the security tiles are configured to:
determine physical statuses of respective regions of the protection circuitry based on probing responses from the respective regions of the protection circuitry; and
report the physical statuses amongst the security tiles.

15. The system of claim 14, wherein the security tiles are further configured to:
determine a status of communication links, wherein the communication links comprise one or more of communication links between the security tiles and the respective regions of the protection circuitry and communication links amongst the security tiles; and
report the status of the communication links amongst the security tiles.

16. The IC device of claim 13, wherein one or more of the security tiles is configured to determine a region of the protection circuitry subject to the physical tampering based on the probing responses.

17. The IC device of claim 11, wherein the functional circuitry is configured as one or more of:
a computer, a printer, a digital imaging device, a smart phone, a control system, a transportation control system, a transportation safety system, an automated teller machine, and a solid-state memory system.

18. A non-transitory computer readable medium encoded with a computer program that comprises instructions to cause a processor to:
construct a design for an integrated circuit device, including to,
place a functional circuit design within an inner region of a first die template, wherein the first die template comprises a first security ring placed in an outer region of the first die template, wherein the first security ring surrounds the functional circuit design, and wherein the first security ring is configured to determine if the first die is subject to a physical attack.

19. The non-transitory computer readable medium of claim 18, wherein the computer program further comprises instructions to cause the processor to:
provide the design with a second die template that comprises a protection circuit design placed within an inner region of the second die template, and a second security ring placed in an outer region of the second die template, wherein the second security ring surrounds the protection circuit design, wherein the second security ring is configured to interface between the first security ring and the protection circuit design, and wherein the protection circuit design is configured to sense a physical attack on the IC device.

20. The non-transitory computer readable medium of claim 18, wherein the computer program further comprises instructions to cause the processor to:
place one of multiple protection circuit designs within an inner region of a second die template, wherein the second die template comprises a second security ring placed in an outer region of the second die template, wherein the second security ring surrounds the protection circuit design, wherein the second security ring is configured to interface between the first security ring and the protection circuit design, and wherein the protection circuit design is configured to sense a physical attack on the IC device.
